(19) United States
(12) Patent Application Publication
(10) Pub. No.: US 2006/0026049 A1
(43) Pub. Date: Feb. 2, 2006

(54) Method for identifying and prioritizing customer care automation

(75) Inventors: Kurt M. Joseph, Austin, TX (US); Benjamin Anthony Knott, Round Rock, TX (US); Robert R. Bushey, Cedar Park, TX (US); Theodore Pasquale, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/901,926

(22) Filed: Jul. 28, 2004

(51) Int. Cl. G06Q 90/00

(52) U.S. Cl. 705/8

(57) ABSTRACT

A method of identifying and prioritizing automated customer care applications for use in connection with interactive voice response systems is disclosed. The method includes receiving a first set of data produced by a first data-driven evaluation process relating to a call center environment responsive to calls received by the interactive voice response systems; receiving a second set of data produced by a second data-driven evaluation process relating to customer preferences with respect to self-service for each of a set of tasks; and generating a prioritized list of automated customer care applications based on the first set of data and the second set of data.

### FIELD OF THE DISCLOSURE

The disclosure generally relates to methods and systems for identifying and evaluating customer care automation applications.

### BACKGROUND

Many call centers are making significant technology investments to enable automated customer care applications to decrease operational costs and to provide new functionality for customers. Such applications often provide convenience and flexibility by allowing users a self-service mechanism to access information about their service. Such applications offer the opportunity for substantial revenue enhancements and operational cost reductions for the service provider. In many implementations, there is a lack of analytical business methods for systematically identifying and prioritizing automated customer care applications. Frequently, such applications are implemented in an arbitrary manner without a complete understanding, quantification, or prioritization of their benefits, costs, and associated effects on business operations and customer service.

Accordingly, there is a need for an improved system and method of identifying and prioritizing automated customer care applications.

### BRIEF DESCRIPTION OF THE DRAWINGS

FIG. 1 is a block diagram that illustrates a system to identify and prioritize automated customer care applications.

FIGS. 2 and 3 are flow charts that illustrate methods of evaluating automated customer care applications.

### DETAILED DESCRIPTION OF THE DRAWINGS

In a particular embodiment, a method of identifying and prioritizing automated customer care applications is disclosed. The method includes receiving interview data derived from call center interviews relating to customer tasks, analyzing customer opening statement data to identify information relating to customer preferences for self-service with respect to the customer tasks, collecting data and metrics relating to customer care to determine cost savings information associated with a plurality of automated customer care applications associated with the customer tasks, and assigning a risk level to each of the plurality of automated customer care applications to identify a level of risk associated with development of each of the automated customer care applications. A prioritized list of the plurality of automated customer care applications based on the interview data, the customer preference information, the cost savings information, and the risk level associated with each of the automated customer care applications is generated.

In another embodiment, a method of identifying and prioritizing automated customer care applications for use in connection with interactive voice response systems is disclosed. The method includes receiving a first set of data produced by an initial data-driven evaluation process relating to a call center environment responsive to calls received by interactive voice response systems. The method also includes receiving a second set of data produced by a subsequent data-driven evaluation process relating to customer preferences for self-service for each of a set of tasks, and generating a prioritized list of automated customer care applications based on the two sets of data.

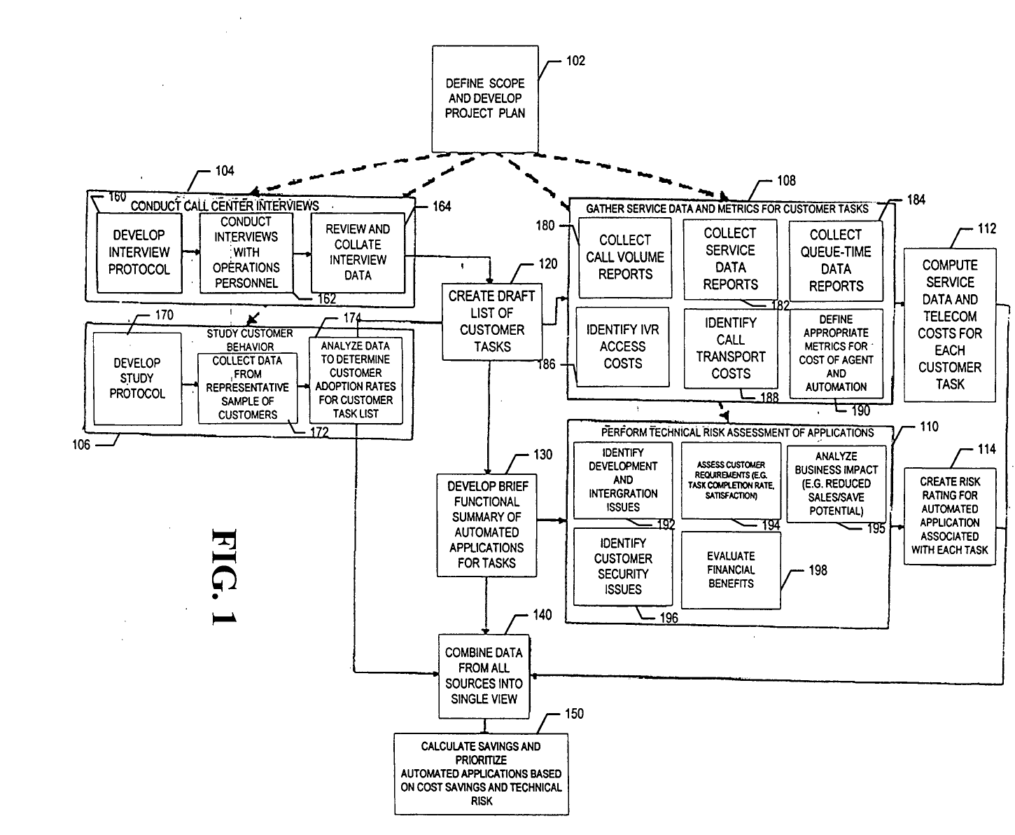

Referring to FIG. 1, an illustrative system for identifying and prioritizing automated customer care applications is shown. The system includes a first portion where a scope and project plan is developed, at 102. The scope and project plan phase 102 produces an output that is fed to four different sub-phases during the automated customer care identification and prioritization process. A first of the sub-phases is to conduct call center interviews 104. A second sub-phase 106 is to study customer behavior. A third sub-phase 108 is to gather service data and metrics for customer tasks, and a fourth sub-phase 110 is to perform technical risk assessment for applications.

The overall system also includes other process steps such as to create an initial list of customer tasks 120, to develop a brief functional summary of automated applications for tasks 130, to create risk ratings for automated applications associated with each task 114, to compute service data and telecom costs for each customer task 112, and to combine data from multiple sources into a single view 140. In addition, the system includes a module for performing a calculation of savings and for prioritizing automated applications based on cost savings and technical risks, at 150.

The first sub-phase 104 of the system includes logic for developing interview protocols 160, conducting interviews with operations personnel 162, and reviewing and collating interview data 164. The results of the interview data collation is fed to logic module 120. The first sub-phase of conducting calls center interviews 104 may be implemented by using an interview protocol that is developed to conduct numerous call center interviews, such as in the range of 25 to 50 interviews, with first line supervisors or team leaders. The interviews are conducted in offices that are representative of various call center functions. The interview protocol process captures information to identify opportunities for automating customer tasks and solicits estimates of time savings and call volumes. The interviews typically produce as many as fifty to seventy ideas that are combined to create a draft initial list of customer tasks that can be automated either fully or partially. Once a list of customer tasks have been identified, tasks that are related may be combined into a single automated application. For instance, the functionality associated with two separate but related tasks, such as a “modem test” and a “network test”, could be combined into a single automated application to handle multiple customer tasks. Thus, related customer tasks may be grouped together.

The second sub-phase 106 includes logic to develop a study protocol 170, to collect data from representative samples of customers 172, and to analyze data to determine customer adoption rates for a customer task list 174. The module 174 is responsive to the task list process 120. The second sub-phase of studying customer behavior 106 may be used to identify customer preferences for various self service tasks. For example, customers may be more willing to use self service for some tasks but not for others and this customer self preference may be important to identify before developing and implementing self service automation programs. However, before determining customer preferences for self service, it may be useful to identify a list of customer tasks that account for most of the customer call volume. To do this, a representative sample of as many as 3000 customer opening statements captured at interactive voice response units is collected, collated, and categorized to create a customer task frequency table that may be used to create multiple task scenarios. These scenarios are presented to a representative group of customers who are asked to state whether they prefer to speak to a customer service agent, to use phone self service, or to use internet self service for each of the scenarios. The result of the study provides information regarding customer preferences for various self service tasks.

The third sub-phase 108 includes logic to collect call volume reports 180, to collect service data reports 182, to collect queue-time data reports 184, to identify interactive voice response (IVR) access costs 186, to identify call transport costs 188, and to define appropriate metrics for determining costs of agent and automation 190. The sub-phase of gathering service data and metrics for customer tasks 108 provides service data and metrics relevant to customer care that may be collected and used to calculate cost savings. For example, call volume by customer task, number of agents per call center, number of call centers affected by a particular task, agent loaded cost, days worked per year, and other metrics may be collected with respect to call savings. This data may be gathered by accessing a variety of reports and resources including call referral reports, vendor reports, customer case reports, such as case detail and call completion time, and IVR access and transport reports. Cost savings may be calculated using the formulas:
Task Cost [Agent]=Agent Cost+IVR Access Cost+Transport Cost 1.
Task Cost [Automation]=Auto Cost+IVR Access Cost 2.
Task Cost [Automation Opt-Out]=[Agent Cost+IVR Access Cost+Transport Cost]×[Customer Opt-Out Rate] 3.
Annualized Cost Savings=Task Cost [Agent]−Task Cost[Auto]+Task Cost [AutoOptOut] 4.

Outputs from the sub process of gathering service data and metrics for customer task 108 is fed to logic to compute service data and telecom cost for each customer task 112.

The system also includes a fourth sub-phase to perform technical risk assessment 110. The fourth sub-phase 110 includes software routines or other logic to identify development and integration issues 192, access customer requirements 194, analyze business impact 195, identify customer security issues 196, and evaluate financial benefits 198 of automated customer care tasks. The output from the fourth sub-phase 110 is fed to logic module 114 to create a risk rating for automated applications associated with each task. The fourth sub-phase 110 of performing technical risk assessment includes providing an assessment of technical risk with respect to development of particular automation implementation processes. The technical risk assessment may be used as a metric to consider during evaluation and prioritization of potential automation applications that have been identified. The technical risk assessment process may involve collecting information, data, and opinions from technical experts that assign risk scores and weights to each application and using such scores as combined to determine a risk level for each application.

The risk assessment may be based on the following factors that influence the level of technical risk associated with developing and implementing a particular self service automation project:
Development and integration [example existing apps, new technology, requirements, dependencies, etc.]
Financial [i.e., cost vs. benefit analysis]
Business Issues [e.g., reduced costs potential]
Security [e.g., user authentication, secure transactions, etc.]
Customer requirements [e.g., customer interface, task completion rate, satisfaction, trust].

During operation of the system illustrated in FIG. 1, output from conducting call center interviews 104 is fed to create a draft list of customer tasks 120. The draft list of potential customer tasks that may be suitable for automation is fed to the second sub-phase 106 to study customer behavior and is fed to the third sub-phase 108 to gather service data and metrics for customer tasks. Service data from the third sub-phase 108 is fed to a computation unit 112 to determine telecom and service data costs for each customer task. The output of the computation is to determine telecom and service data cost for each customer task. The output of computation unit 112, as well as output from logic 114 dealing with technical risk assessments, is responsive to the fourth sub-phase 110, and is provided to combination logic 140.

The combination logic module 140 receives input from the second sub-phase of customer behavior 106, and receives an output of logic 130 providing a summary of automated application tasks. The combination logic 140 combines data from multiple sources and sub-phases to provide a single view of a list of customer tasks and the relevant data from each of the sub-phases. Logic 150 for performing calculation of cost savings is also used to prioritize and create a prioritized automated application list based on the cost savings data and technical risk data. Thus, from an initial scope and project plan, specific potential customer tasks suitable for automation are identified and prioritized to create a prioritized automation list produced by final output logic 150. The prioritized and automated list of customer tasks may be printed on reports or displayed, such as via a terminal or may be remotely distributed over a computer network.

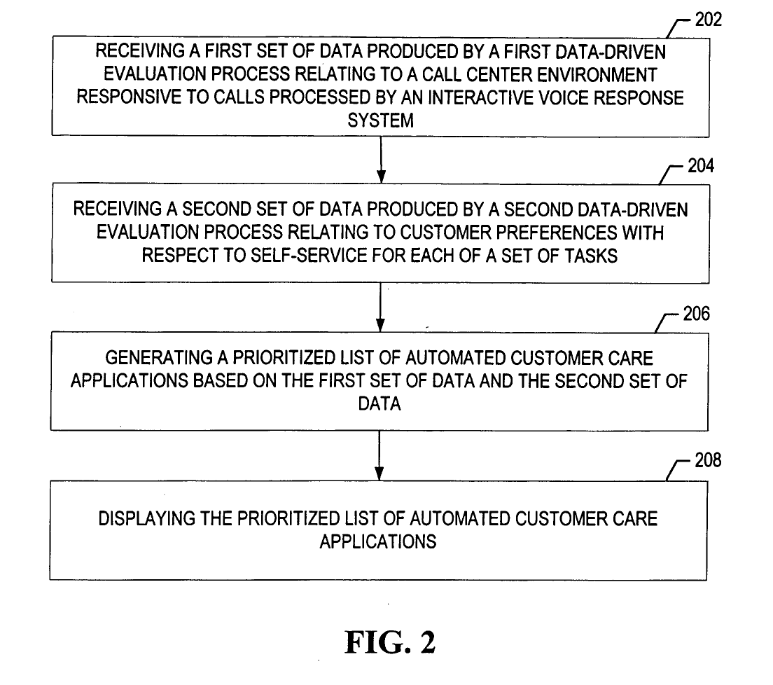

Referring to FIG. 2, a method of identifying and prioritizing automated customer care applications for use in connection with interactive voice response systems is shown. A first set of data produced by a first data-driven evaluation process related to a call center environment and responsive to calls processed by the interactive voice respond system is received, at 202. A second set of data produced by a second data-driven evaluation process related to customer preferences with respect to self-service for each of a set of tasks is received at 204. A prioritized list of automated customer care applications based on the first set of data and the second set of data is generated, at 206. The prioritized list of automated customer care applications is then displayed and or printed, at 208. In a particular embodiment, the prioritized list of generated automated customer care applications is based on predicted or estimated automation cost savings data and/or on technology risk assessment data. In a particular embodiment, the first set of data may include interview data derived from call center interviews, and the second set of data may include customer opening statement data that is retrieved by at least one of a plurality of interactive voice response systems. The disclosed method provides a process for identifying customer care applications in the context of interactive voice response units and supporting call centers for desired implementation. The prioritized automated customer care applications are deemed to have lower technical risks and higher effect on cost savings and efficient operations. In addition, customer preference information may be included as a factor in determining the prioritization of the automated customer care application implementation list.

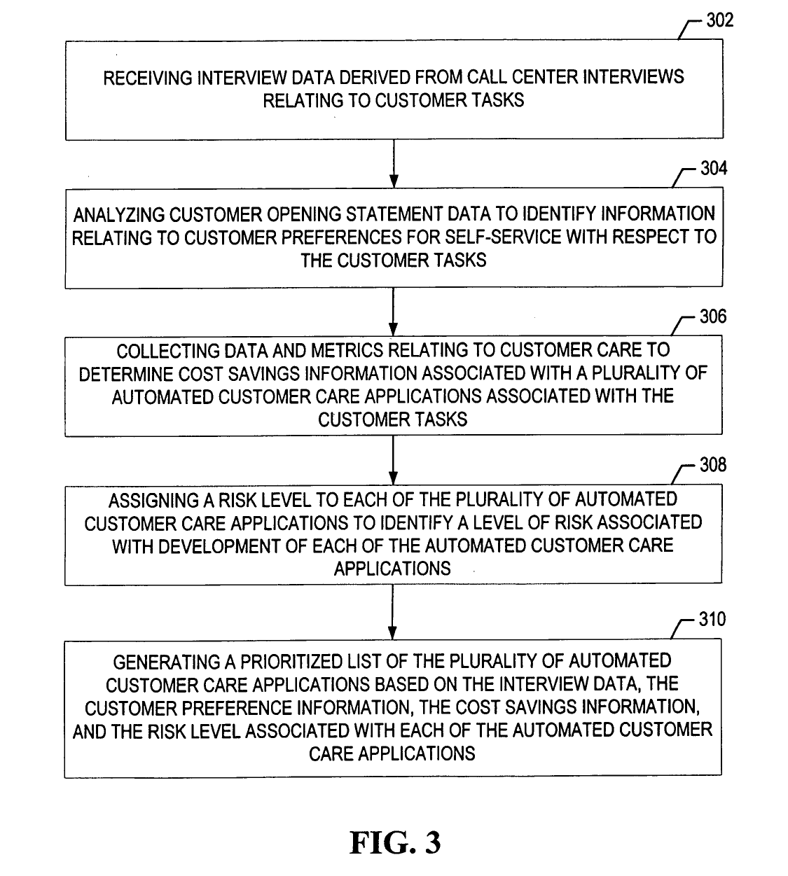

Referring to FIG. 3, a method of identifying and prioritizing automated customer care applications is disclosed. The method includes receiving interview data derived from call center interviews related to customer tasks, at 302. The method further includes analyzing customer opening statement data to identify information relating to customer preferences for self service with respect to particular customer tasks, at 304. The opening statement data may be collected through the use of interactive voice response units and aggregated at call centers using manual operators and associated computer terminals. The data and metrics related to customer care are collected to determine cost savings information associated with a plurality of automated customer care applications and customer tasks, at 306. A risk level is assigned to each of the plurality of automated customer care applications to identify a level of technical risk associated with the development and implementation of each of the automated customer care applications, at 308. The risk assignment may be made through either manual interview data of technical experts or through an automated software system that evaluates various risk factors associated with product development. Based on the interview data, the customer preference information, the cost savings information, and the technical risk level associated with each of the automated customer care applications, a prioritized list of the plurality of automated customer care applications is generated, at 310. In a particular embodiment, the prioritized list of automated customer care applications is associated with at least one of the following: call volume data, customer adoption rate data, estimated return on investment data, and technical risk data.

In addition, the interview data may be retrieved in response to an interview with call center callers. The interview data may include captured information related to identified opportunities for automating customer tasks, information related to cost savings, and information related to call volume. Interview data may be analyzed to create a list of customer tasks considered suitable for at least partial automation, if not full automation. Customer opening statements may be sampled at IVR units to collect customer task data and to categorize the customer task data to create a customer task frequency table. The customer task frequency table may also be used to generate a plurality of task scenarios and to determine a customer preference level associated with either phone self service or internet self service for each of the plurality of task scenarios. In a particular example, an agent task cost may be determined based on agent cost, interactive voice response system access cost, and transport cost. Also, the automation task cost may be determined based on a cost of automation and the interactive voice response system access cost.

As a result of executing the above process as disclosed, a list of automated customer care applications ordered from highest to lowest in priority based on cost savings and technical risks may be generated.

An example of a prioritized list is shown in table 1 below:

| | | | Customer | Annualized ROI | |
|---|---|---|---|---|---|
| Support | | Call Volume | Adoption | in $M (2003 | Technical |
| Type | Candidate Self-Service Speech Application | (in M) | Rate | data) | Risk (H, M, L) |
| DSL | Check connectivity - network status, ping test, modem | 2.75 | 48% | $5.12 | M |
| | test/check filters, etc | | | | |
| DSL | Check order status/due date | 0.52 | 84% | $2.25 | M |
| DSL | Get balance and payment info, make payment, update | 1.95 | 60% | $1.54 | M |
| | method of payment and/or credit card information | | | | |
| DSL | Check equipment status | 0.26 | 84% | $1.24 | M |
| DSL | Reset password | 0.32 | 82% | $1.14 | L |
| DSL | Verify customer account information | 13.60 | 60% | $1.03 | M |
| DSL | Check trouble ticket status¹ | 0.24 | 85% | $0.90 | M |

| | |
|---|---|
| Total | $13.23 M |

The disclosed method identifies and prioritizes automated applications based on separate data-driven processes to build a comprehensive view of IVR automation opportunities. Reports produced by the disclosed method and system may be used to provide informed strategic planning, to create business cases for individual projects and determine prioritization of projects for planning purposes, and to develop project plans with critical paths and dependencies. In addition the disclosed system facilitates vendor proposals aligned with business needs and defines baseline metrics and tracking of such metrics for success during project development.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of identifying and prioritizing automated customer care applications, the method comprising:
receiving interview data derived from call center interviews relating to customer tasks;
analyzing opening statement data to identify information relating to customer preferences for self-service with respect to the customer tasks;
collecting data and metrics relating to customer care to determine cost savings information relating to a plurality of automated customer care applications associated with the customer tasks;
assigning a risk level to each of the plurality of automated customer care applications to identify a level of risk associated with development of each of the automated customer care applications;
generating a prioritized list of the plurality of automated customer care applications based on the interview data, the customer preference information, the cost savings information, and the risk level associated with each of the automated customer care applications.

2. The method of claim 1, wherein the prioritized list of automated customer care applications is associated with at least one of call volume data, customer adoption rate data, estimated return on investment data, and technical risk data.

3. The method of claim 1, wherein the interview data is retrieved in response to an interview with call center callers, the interview data capturing information related to identifying opportunities for automating customer tasks, information related to cost savings, and information relating to call volume.

4. The method of claim 3, further comprising analyzing the interview data to create a list of customer tasks that can be at least partially automated.

5. The method of claim 1, wherein the step of analyzing opening statement data includes sampling a plurality of customer opening statements to collect customer task data and categorizing the customer task data to create a customer task frequency table.

6. The method of claim 5, further comprising generating a plurality of task scenarios based on the customer task frequency table.

7. The method of claim 6, further comprising determining a customer preference level associated with at least one of phone self-service and internet self-service for each of the plurality of task scenarios.

8. The method of claim 1, wherein the data and metrics relating to customer care include call volume by customer task data, number of agents per call center, number of call centers affected by each task, agent loaded cost, and number of days worked per year.

9. The method of claim 1, wherein an agent task cost is determined based on an agent cost, an interactive voice response system access cost, and a transport cost.

10. The method of claim 9, wherein an automation task cost is determined based on a cost of automation and the interactive voice response system access cost.

11. The method of claim 10, wherein an automation opt-out task cost is determined based on a sum of agent cost, interactive voice response system cost and transport cost multiplied by a customer opt-out rate.

12. The method of claim 11, wherein a cost savings metric is determined based on the agent task cost, the automation task cost, and the opt-out task cost.

13. The method of claim 1, wherein the risk level is determined based on risk scores and weights provided by technical experts.

14. A method of identifying and prioritizing automated customer care applications for use in connection with interactive voice response systems, the method comprising:
receiving a first set of data produced by a first data-driven evaluation process relating to a call center environment responsive to calls received by the interactive voice response systems;
receiving a second set of data produced by a second data-driven evaluation process relating to customer preferences with respect to self-service for each of a set of tasks; and
generating a prioritized list of automated customer care applications based on the first set of data and the second set of data.

15. The method of claim 14, wherein generation of the prioritized list of automated customer care applications is further based on automation cost savings data.

16. The method of claim 15, wherein generation of the prioritized list of automated customer care applications is further based on a technology risk assessment.

17. The method of claim 14, wherein the first set of data includes interview data derived from call center interviews.

18. The method of claim 14, wherein the second set of data is derived from customer opening statement data retrieved by at least one of the interactive voice response systems.

19. The method of claim 14, wherein the first data-driven evaluation process in an initial data-driven evaluation process and the second data-driven evaluation process is subsequent to the initial data-driven evaluation process.
